(19) United States
(12) Patent Application Publication
(10) Pub. No.: US 2011/0055092 A1
(43) Pub. Date: Mar. 3, 2011

(54) Electronic Systems and Methods for Aggregating and Distributing Environmental Credits

(75) Inventors: Michael Fargano, Louisville, CO (US); Robin Seguin, Arvada, CO (US)

(73) Assignee: QWEST COMMUNICATIONS INTERNATIONAL, INC., Denver, CO (US)

(21) Appl. No.: 12/552,129

(22) Filed: Sep. 1, 2009

(51) Int. Cl. G06Q 50/00; G06Q 10/00

(52) U.S. Cl. 705/317

(57) ABSTRACT

An electronic system for offering and allocating environmental offset credits by a service provider comprises an environmental credit management server in communication with the service provider and adapted to manage a consumer's selection and allocation of environmental offset credits. The system includes, in one embodiment, a database management server in communication with the service provider and the consumer and a plurality of environmental offset credit providers in communication with the database management server. The database management server is adapted to store information concerning the plurality of environmental credit service providers and the application management server is adapted to selectively provide information to the consumer concerning the plurality of environmental credit providers.

### FIELD OF THE INVENTION

Aspects of the present invention relate to electronic or other computerized systems for the collection, aggregation and distribution of environmental offsets and other credits.

### BACKGROUND

The idea and desire for businesses and consumers alike to become “carbon neutral” has gained a strong influence in our society. Beyond reducing individual consumption through reduction and efforts to produce less waste and use more renewable energy, and where reduction has reached its limit or comfortable threshold, carbon offsets can make up the rest of the equation to become carbon neutral.

Carbon offsets are a form of trade. When an offset is purchased, projects are funded that reduce greenhouse gas (GHG) emissions. The projects might restore forests, update power plants and factories or increase the energy efficiency of buildings and transportation. Carbon offsets provide a means to reduce the global GHG total instead of making radical or impossible reductions on an individual basis. GHG emissions mix quickly with the air and, unlike other pollutants, spread around the entire planet. Because of this, it doesn't really matter where GHG reductions take place if fewer emissions enter the atmosphere.

At this time, carbon offsets are voluntary. People and businesses buy them to reduce their carbon footprints or build up their green image. Purchasing carbon offsets can counteract specific activities like air travel and driving or events like weddings and conferences.

As people and businesses become more aware of their own contributions to global warming, some turn to carbon offsets as a way to go carbon neutral. Offset companies first estimate a customer's personal carbon output. Their Web sites include carbon calculators that determine the total GHG produced by a year's worth of electricity or driving, an event or even a round-trip flight. Offset companies then charge an amount based on their own GHG price per ton. The money funds programs that offset an equal amount of emissions. Some offset companies allow customers to choose their projects; others do not.

In general terms, a carbon offset is a form of financial instrument that represents some specified reduction in greenhouse gas emissions. While there are many sources of greenhouse gases, carbon offsets are measured in metric tons of carbon dioxide-equivalent. One carbon offset represents the reduction of one metric ton of carbon dioxide, or its equivalent in other greenhouse gases.

There are two primary markets for carbon offsets. In the larger compliance market, companies, governments or other entities buy carbon offsets in order to comply with caps on the total amount of carbon dioxide they are allowed to emit. In the much smaller voluntary market, individuals, companies, or governments purchase carbon offsets to mitigate their own greenhouse gas emissions from transportation, electricity use, and other sources. For example, an individual might purchase carbon offsets to compensate for the greenhouse gas emissions caused by personal air travel.

Offsets are typically generated from emissions-reducing projects. The most common project type is renewable energy, such as wind farms, biomass energy, or hydroelectric dams. Other common project types include energy efficiency projects, the destruction of industrial pollutants or agricultural byproducts, destruction of landfill methane, and forestry projects. Purchase and withdrawal of emissions trading credits also occurs, which creates a connection between the voluntary and regulated carbon markets.

Carbon offsetting as part of a “carbon neutral” lifestyle has gained some appeal and momentum mainly among consumers in western countries who have become aware and concerned about the potentially negative environmental effects of energy-intensive lifestyles and economies. The Kyoto Protocol has sanctioned offsets as a way for governments and private companies to earn carbon credits which can be traded on a marketplace. The protocol established the Clean Development Mechanism (CDM), which validates and measures projects to ensure they produce authentic benefits and are genuinely “additional” activities that would not otherwise have been undertaken. Organizations that have difficulty meeting their emissions quota are able to offset by buying CDM-approved Certified Emissions Reductions. The CDM encourages projects that involve, for example, renewable energy production, changes in land use, and forestry, although not all trading countries allow their companies to buy all types of credit.

The commercial system has contributed to the increasing popularity of voluntary offsets among private individuals, companies, and organizations as well as investment in clean technologies, clean energy and reforestation projects around the world. Offsets may be cheaper or more convenient alternatives to reducing one's own fossil-fuel consumption. However, some critics object to carbon offsets, and question the benefits of certain types of offsets

Aside from the physical benefits of offset projects, voluntary commercial offsets make customers look beyond the limits of their own households or businesses. Before buying offsets, people presumably first reduce their own emissions. They may limit travel, choose energy-efficient appliances or convert to renewable energy. After they cannot reduce any more, or if they find it uneconomical to do so, carbon offsets help make up for the rest.

Some purchasers, however, make no attempt to reduce their emissions before buying carbon offsets. Critics claim that offsets give people who are unwilling to change their lifestyle an easy, monetary way out of taking real responsibility. Offsets do not provide carbon atonement for a trip by private jet or the construction of a sprawling mansion. When the average American car produces more CO2 in a year than the total annual production of an average global citizen, it's clear that monetary investments cannot replace actual GHG reductions in developed nations.

Carbon offsets have also become the mode in corporate responsibility. Companies with green reputations attract a public increasingly concerned with the environment and global warming. Because carbon offsets are voluntary, generous purchases can help strengthen a company's environmental image. Some companies make real efforts to modify their operations, create fewer GHG emissions and offset the rest. But businesses can also conceal lax environmental standards with highly promoted carbon offsets. Environmentalists call this type of deception greenwashing.

While one method of aggregating carbon offsets is to purchase them on the open market either directly from providers of the offsets, or through third party brokers, this does not adequately account for the large scale consumer desire to contribute to reductions in GHG emissions. A system does not exist to allow a company or other service provider with an established customer base to enable its customers to select the type of environmental offset that is allocated based on some level of conservation activity or lifestyle choice.

### SUMMARY OF THE INVENTION

In accordance with a first aspect, a system for offering and allocating environmental offset credits by a service provider comprises an environmental credit management server in communication with the service provider and adapted to manage a consumer's selection and allocation of environmental offset credits.

In another embodiment the system includes a database management server in communication with the service provider and the consumer and a plurality of environmental offset credit providers in communication with the database management server. In accordance with one aspect, the database management server is adapted to store information concerning the plurality of environmental credit service providers and the application management server is adapted to selectively provide information to the consumer concerning the plurality of environmental credit providers.

In other aspects a user interface is provided through the environmental credit management server and is adapted to enable the consumer to select one or more environmental offset credits from one or more of the plurality of environmental offset credit providers.

In another embodiment a machine implemented method of offering and allocating environmental offset credits to a customer of a service provider comprises receiving from a database management server, information concerning a plurality of environmental credit service providers, receiving, at an environmental credit management server in communication with the service provider, the information concerning the plurality of environmental credit service providers, providing the information concerning the plurality of environmental credit service providers to the service provider customer, and enabling, via a user interface provided by the environmental management server, the customer to select one or more environmental offset credits from one or more of the plurality of environmental offset credit providers.

Other aspects and features are contemplated and are more fully described in the following description and as would be known to one of skill in the art.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings, wherein:

FIG. 1 is a architecture diagram of a known environmental offset credit purchasing system;

FIG. 2 is one specific embodiment of an architecture diagram of an environmental offset credit aggregation and distribution system;

FIG. 3 is one specific embodiment of a method of collecting, organizing and distributing environmental offset credits;

FIG. 4 is another specific embodiment of an architecture diagram of an environmental offset credit aggregation and distribution system

FIG. 5 is another specific embodiment of a method of collecting, organizing and distributing environmental offset credits; and

FIG. 6 is one specific example of an architecture diagram for a computer system used in conjunction with various aspects of the inventions described herein.

### DETAILED DESCRIPTION

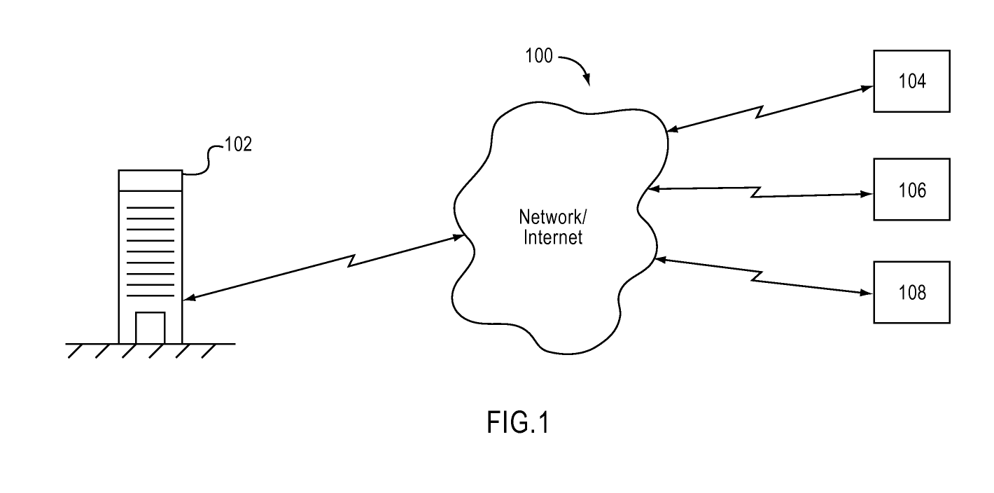

With reference to FIG. 1, an overview architecture diagram is shown that illustrates a typical scenario where an institution such as a company or other service provider 102 might purchase environmental offset credits from one or more organizations 104, 106 and 108. Organizations 104, 106 and 108 in one example are third parties that sell or otherwise provide carbon offsets or another form of environmental credit for purchase on the open market. The organizations 104, 106 and 108 may sell these credits to either individuals or only to larger organizations. Connected via a network 100 such as the internet or other wide area network, service provider 102 engages with at least one of the offset credit providers 104, 106 and 108 and arranges for the purchase of some amount of offset credit. Credit providers 104, 106 and 108 can be one of many different types of providers or services. For example, sources of carbon offsets may include the following:

Renewable Energy—Renewable energy offsets commonly include wind power, solar power, hydroelectric power and bio-fuel. Some of these offsets are used to reduce the cost differential between renewable and conventional energy production, increasing the commercial viability of a choice to use renewable energy sources. Renewable Energy Credits (RECs) are also sometimes treated as carbon offsets, although the concepts are distinct. Whereas a carbon offset represents a reduction in greenhouse gas emissions, a REC represents a quantity of energy produced from renewable sources. To convert RECs into offsets, the clean energy must be translated into carbon reductions, typically by assuming that the clean energy is displacing an equivalent amount of conventionally produced electricity from the local power grid. This is known as an indirect offset (because the reduction doesn't take place at the project site itself, but rather at an external site).

Methane Collection and Combustion—Some offset projects consist of the combustion or containment of methane generated by farm animals, landfills or other industrial waste. Methane has a global warming potential 23 times that of CO2. When combusted, each molecule of methane is converted to one molecule of CO2, thus reducing the global warming effect by 96%. Methane can also be processed using an anaerobic digester which generates electricity or heat.

Energy Efficiency—While carbon offsets which fund renewable energy projects help lower the carbon intensity of energy supply, energy conservation projects seek to reduce the overall demand for energy. Carbon offsets in this category fund projects of several types. Cogeneration plants generate both electricity and heat from the same power source, thus improving upon the energy efficiency of most power plants which waste the energy generated as heat. Fuel efficiency projects replace a combustion device with one which uses less fuel per unit of energy provided. Assuming energy demand does not change, this reduces the carbon dioxide emitted. Energy-efficient buildings reduce the amount of energy wasted in buildings through efficient heating, cooling or lighting systems. In particular, the replacement of incandescent light bulbs with compact fluorescent lamps can have a drastic effect on energy consumption. New buildings can also be constructed using less carbon-intensive input materials.

Destruction of Industrial Pollutants—Industrial pollutants such as hydrofluorocarbons (HFCs) and perfluorocarbons (PFCs) have a global warming potential many thousands of times greater than carbon dioxide by volume. Because these pollutants are easily captured and destroyed at their source, they present a large and low-cost source of carbon offsets. As a category, HFCs, PFCs, and N2O reductions represent 71% of offsets issued.

Land Use and Forestry—Land use, land-use change and forestry (LULUCF) projects focus on natural carbon sinks such as forests and soil. Deforestation, particularly in Brazil, Indonesia and parts of Africa, account for about 20% of greenhouse gas emissions. Deforestation can be avoided either by paying directly for forest preservation, or by using offset funds to provide substitutes for forest-based products. For example, almost half of the world's people burn wood (or fiber or dung) for their cooking and heating needs. Fuel-efficient cook stoves can reduce fuel wood consumption by 30 to 50%. There are a number of different types of LULUCF projects. Avoided deforestation is the protection of existing forests. Reforestation is the process of restoring forests on land that was once forested. Afforestation is the process of creating forests on land that was previously unforested, typically for longer than a generation. Soil management projects attempt to preserve or increase the amount of carbon sequestered in soil.

Because of its commercial size and availability of funds and other trading resources, when a company, service provider or other large organization such as service provider 102 wants to purchase carbon allowances or other credits to offset its own activities, it may engage with existing emission trading schemes. These trading schemes include organizations such as the Regional Greenhouse Gas Initiative, the European Emissions Trading Scheme, or one of the other legally mandated cap-and-trade programs that exist. By purchasing the allowances that power plants, oil refineries, and industrial facilities need to hold to comply with a cap, voluntary purchases tighten the cap and force additional emissions reductions. Once a particular carbon offset project has been accredited by an organization such as the UNFCCC a carbon offset project can be used as carbon credit and linked with official emission trading schemes, such as the European Union Emission Trading Scheme or Kyoto Protocol, as Certified Emission Reductions.

The voluntary Chicago Climate Exchange also includes a carbon offset scheme that allows offset project developers to sell emissions reductions to CCX members who have voluntarily agreed to meet emissions reduction targets.

The Western Climate Initiative, a regional greenhouse gas reduction initiative by states and provinces along the western rim of North America, includes an offset scheme. Likewise, the Regional Greenhouse Gas Initiative, a similar program in the northeastern U.S., includes an offset program. A credit mechanism that uses offsets may be incorporated in proposed schemes such as the Australian Carbon Exchange.

While the above schemes and large offset organizations are readily available and easily accessible by corporate organizations and otherwise sophisticated buyers, they are typically not for the average individual, family or small organization looking to offset their personal carbon footprint or to otherwise lower their greenhouse gas emissions. In addition, while a company or service provider may gain good will by directly offsetting its own carbon consumption practices, the goodwill available to a service provider associated with offering its customers or clients the option of participating in one or more large scale offset trading schemes is also appealing to both the consumer and the service provider.

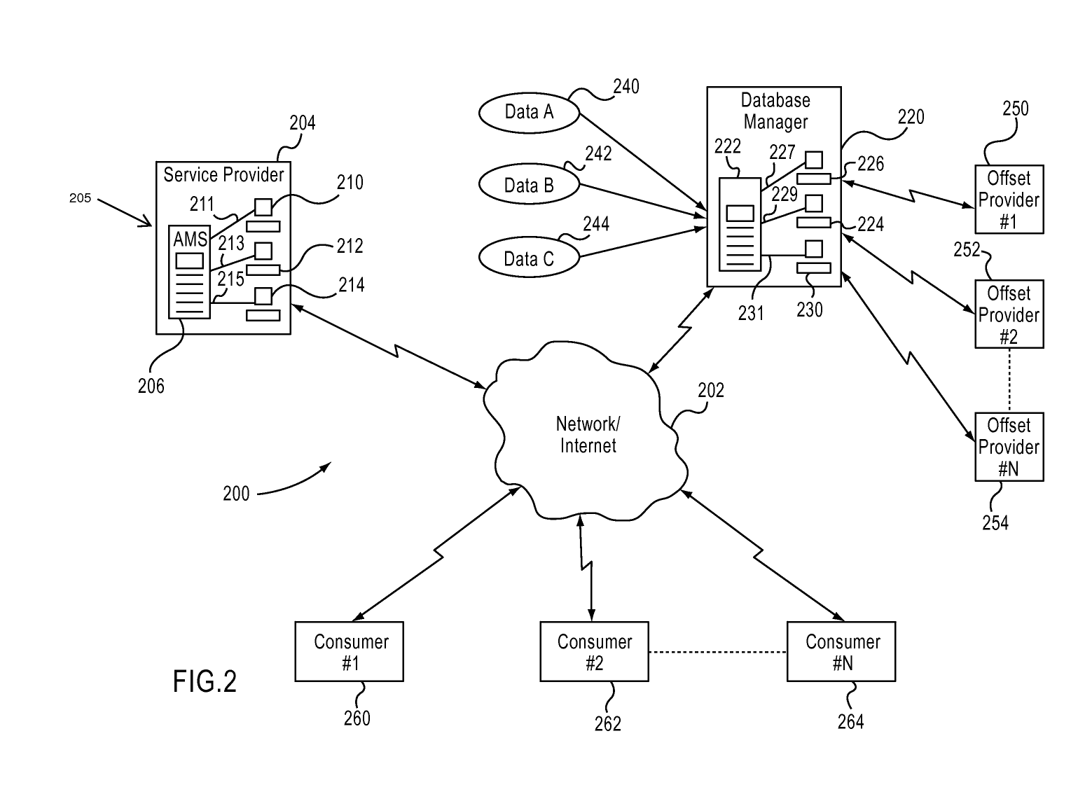

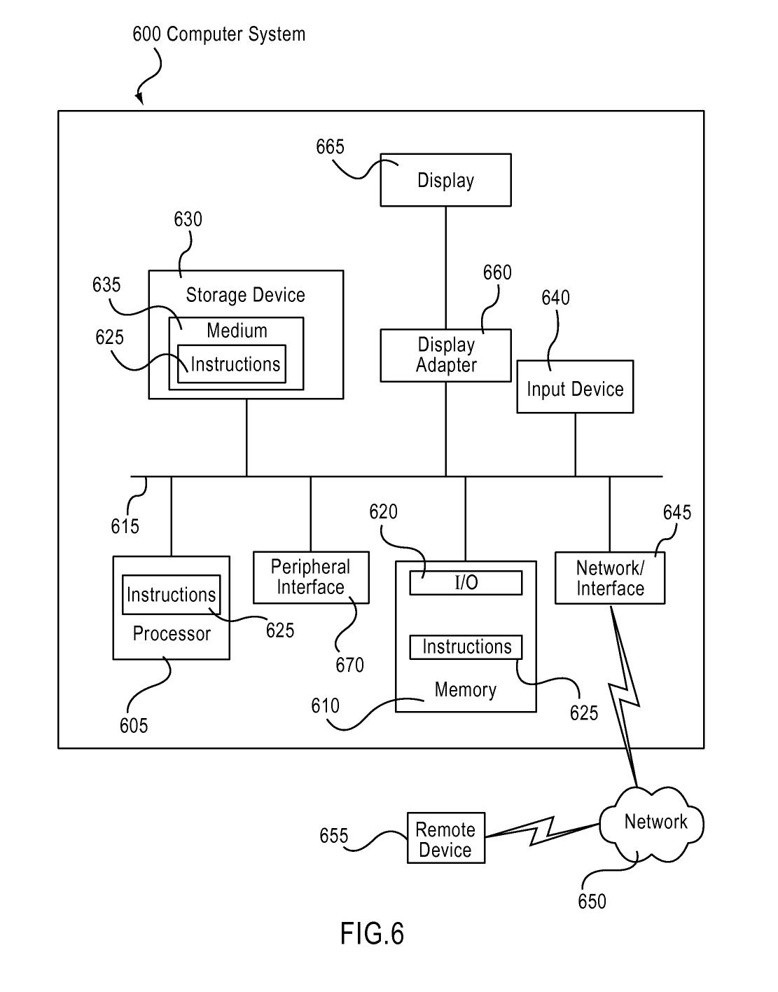

FIG. 2 illustrates a system 200 where an end user or other consumer 260, 262 and 264 has the ability to participate with or access one or more environmental offset providers that are typically only available to larger organizations. Referring to FIG. 2, service provider 204 includes an application manager 205 including an application server 206 which may be one or more types of application management servers or environmental credit management servers designed within a computer structure to enable users 210, 212 and 214 to operatively engage the one or more environmental offset providers 250, 252 and 254. The server 206 may be one of several computer hardware systems, such as the system described in conjunction with FIG. 6, that is adapted to store and run a set of computer instructions in the form of software code or other computer executable instructions. In one specific embodiment, the server 206 couples with an interface 210, 212 or 214 for a user associated with the service provider 204 to manage, allocate and offer environmental offset credits to one or more of the service provider customers 260, 262 and 264. Communication channels 211, 213 and 215 link the interfaces to the server 206.

The application management server 206 is also adapted, in one or more specific embodiments, to gather environmental offset credit information from a database manager 220. The database manager 220 includes a database server 222 coupled via communication channels 227, 229 and 231 to one or more user interfaces 226, 228 and 230. In one example, the database manager acts as a clearinghouse or consolidator of the environmental offset credit information offered by offset providers 250, 252 and/or 254. Several pieces of information are typically needed to determine the overall value of a particular offset credit. This includes the type and availability of the particular credit as well as the magnitude of the carbon reduction available per dollar or amount of effort contributed. In order to maintain uniformity in these allocations, certain standards bodies exist to control and dictate the value of any particular offset and to certify any particular offset program. While accounting systems might differ on precisely what constitutes a valid offset for voluntary reduction systems and for mandatory reduction systems, formal standards for quantification do exist based on collaboration between emitters, regulators, environmentalists and project developers. These standards include the Voluntary Carbon Standard, Green-e Climate, Chicago Climate Exchange and the CDM Gold Standard, the latter of which expands upon the requirements for the Clean Development Mechanism of the Kyoto Protocol. In one or more embodiments described herein, offset accounting may address the following basic areas:

Baseline and Measurement—What emissions occur in the absence of a proposed project and how are the post-project emissions measured.

Additionality—Would the project occur anyway without the investment raised by selling carbon offset credits. For example, there are two common reasons why a project may lack additionality: (a) if it is intrinsically financially worthwhile due to energy cost savings, and (b) if it had to be performed due to environmental laws or regulations.

Permanence—Are some benefits of the reductions reversible? (for example, trees may be harvested to burn the wood, and does growing trees for fuel wood decrease the need for fossil fuel) If woodlands are increasing in area or density, then carbon is being sequestered. After roughly 50 years, newly planted forests will reach maturity and remove carbon dioxide.

Database manager 220 and the included server 222 may be coupled with one or more data sources 240, 242 and 244 representing one or more storage points for the accounting and allocation information described above. In addition, the database manager can, in one embodiment, store specific information about a focused environmentally friendly use, such as the green house gas reduction realized from replacing a certain number of light bulbs with compact fluorescent bulbs, reducing the number of car miles driven, telecommuting one or more days per week, or various other carbon reducing activities. Database manager can thus consolidate the information provided by any or all of the data sources 240, 242, and 244 and the offset providers 250, 252 and 254.

The collection and allocation system 200 can be used to provide one or more individual end-user consumers 260, 262, 264 with the option of selecting or otherwise participating in carbon offset projects that would not otherwise be available to an individual or small organization.

While a system constructed in accordance with aspect of the inventions described herein offers an end-user access to global carbon reduction efforts and the associated credits, it may also provide the service provider 204 with the ability to leverage this broad accessibility to carbon credits in order to establish or increase its customer good will. For instance, in exchange for the customer contracting for some service with the service provider, the service provider might agree to provide a certain number of carbon offset credits and allow the customer to select which particular credit is purchased by the service provider. This type of system can be combined with a company's overall corporate strategy and goals for carbon reduction.

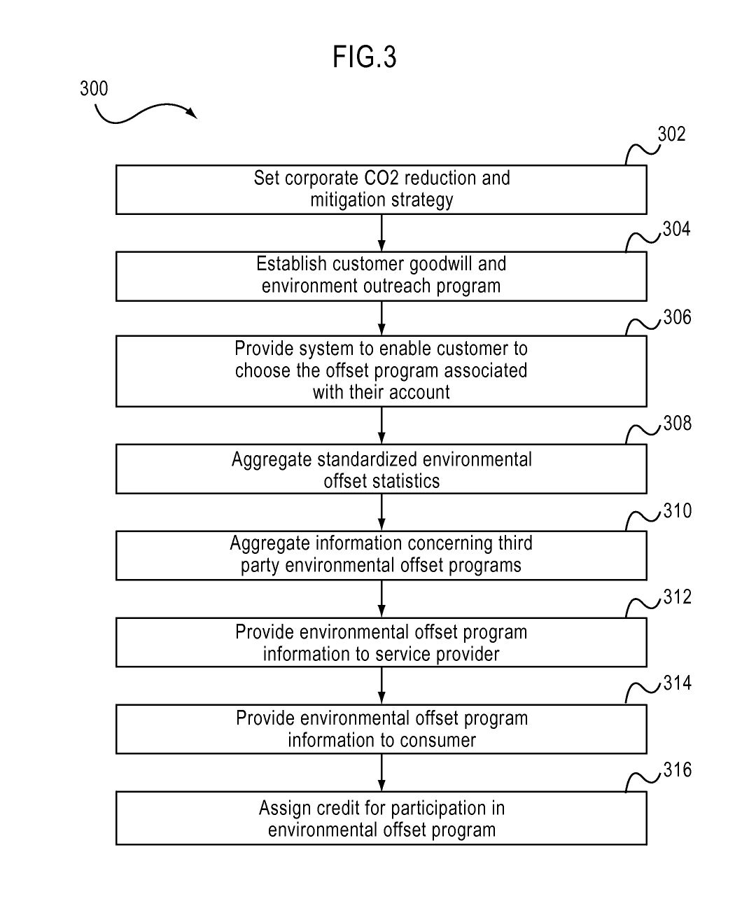

FIG. 3 describes one method that enables a company or other service provider to reach out to its customers in order to allocate which carbon or environmental offset programs it engages in. The method 300 of FIG. 3 may be implemented as part of a broad-based corporate program to increase customer goodwill and also meet internal carbon mitigation goals.

Initially, a service provide or other company will set an overall corporate carbon reduction and mitigation strategy at 302. This type of strategy may be part of an on-going process in which the provision of carbon offsets may be combined with other methods of increasing customer good-will or various other corporate marketing or sales promotion strategies. The company global carbon reduction/mitigation strategy may consider many types of offset programs in addition to those addressed by the inventions described herein. When establishing these company goals, various contributing factors may be considered including any applicable standards, government or corporate mandates, regulations and other laws regarding carbon footprints. Assuming that some form of carbon offset is appropriate, the service provider establishes a customer goodwill and environmental outreach program at 304. The outreach program may include one of several mechanisms for allowing a customer to choose the specific environmental reduction program that he wants to participate in or direct the service to participate in. For example, the service provider may make low-energy appliances available (such as a low energy light bulb, modem, cable box, etc.). Alternatively, the service provider may offer to participate in, or donate money to, a third party offset provider designated by the customer. In one specific embodiment, the service provider may offer these choices in exchange for an extended contract with the customer. As a part of the overall system, the service provider gives the customer access to or enables the customer to engage with a system for selecting or otherwise choosing the offset program associated with their account at 306.

In one example, a telecommunications provider that provides its customers with voice, data and/or video service may offer the customer to sign up for a two year contract (or other time frame) and agree to contribute 10% of the total contract value to a third party environmental offset provider chosen by the customer. A user interface may be provided to the customer that allows the customer to select which particular program the company will participate in.

Included in the determination of whether and to what extent to provide any particular offset program to a customer is a cost-benefit assessment. A cost-benefit assessment can include the potential value of the good will generated with the individual customer as well as the overall community, as well as the cost-benefit associated with electing to proceed with other carbon reduction programs. Customer good will may be in the form of developing a larger customer base or retaining existing customers.

As a part of enabling a customer to have access to a variety of third party offset credit providers, a system constructed in accordance with aspects of the inventions described herein allows the aggregation of many different standardized environmental offset statistics 308 and the aggregation of information concerning many different third party environmental offset programs 310. The systems, servers, and communications protocols described above in conjunction with FIG. 2 enables this collective information to be aggregated for use by the service provider in the methods described in conjunction with FIG. 3. Once the aggregated data is collected and assembled, it is provided in one form to the service provider at 312, where it can determine which one to provide access to its customers, and determine the vehicle by which its customers can participate in those particular offset programs, e.g. how large a donation or how many energy reducing appliances are attributed to the particular customer. In another form the information is then provided to the customer at 314 where the customer can select which program to participate in. Alternatively, the actual carbon credits associated with any particular action may be assigned to the service provider, the customer, or split between the two in any proportion at 316.

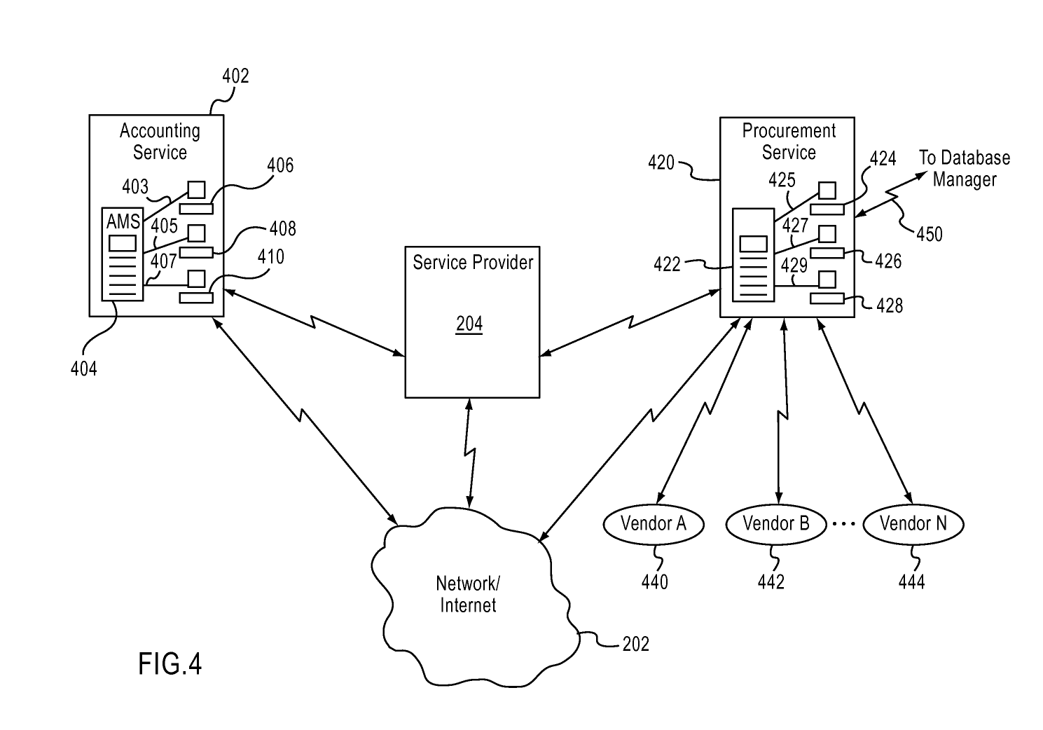

FIG. 4 is an alternative embodiment of a system showing the inclusion of an environmental offset accounting manager 402 and a procurement manager 420. While FIG. 4 shows accounting manager 402 and procurement manager 420 as distinct components coupled to the service provider 204, it should be understood that accounting manager 402 and procurement manager 420 may be a part of the service provider structure or otherwise encompassed with the service provider 204. The accounting manager 402 and the procurement manager 420 are coupled via a telecommunications link to the service provider and/or a large area network 202 such as the internet. Accounting manager 402 includes an accounting management server 404 coupled via communication channels 403, 405, and 407 to one or more user interfaces 406, 408 and 410. The accounting server 404 may be one of several computer hardware systems, such as the system described in conjunction with FIG. 6, that is adapted to store and run a set of computer instructions in the form of software code or other computer executable instructions. In one more specific embodiment, the accounting server 404 couples with an interface 406, 408 or 410 for a user associated with the accounting manager 402 to manage, allocate and offer environmental offset credits to one or more of the service provider customers described above. Communication channels 403, 405 and 407 link the interfaces to the server 404.

Procurement manager 420 includes a procurement management server 422 coupled via communication channels 425, 427, 429 to one or more user interfaces 424, 426, and 428. The procurement management server 422 may be one of several computer hardware systems, such as the system described in conjunction with FIG. 6, that is adapted to store and run a set of computer instructions in the form of software code or other computer executable instructions. In one specific embodiment, the procurement server 422 couples with an interface 424, 426, and 428 for a user associated with the procurement manager 420 to purchase or otherwise obtain environmental offset credits to one or more of the service provider customers described above. Communication channels 425, 427, and 429 link the interfaces to the procurement server 422. Procurement manager 420 is coupled to one or more vendors 440, 442 and 444 that sell or otherwise offer carbon reducing, low-energy, or other environmentally friendly products for purchase.

As shown in FIG. 4, service provider 204 has the ability to directly purchase, through the procurement manager 420, one or more low-energy or environmentally friendly products such as compact fluorescent light bulbs, energy saving appliances, or any number of other consumer products. After purchasing these items from one or more of the vendors 440, 442 and 444, service provider 420 may then offer those products directly to its customers in accordance with the processes and systems described in conjunction with FIGS. 2 and 3, or one of the variations on those systems. Accounting manager 404 provides for the service provider 204 to processes and allocate the environmental offset credits associated with the products or services that it offers to its customers, or otherwise acquires from the vendors 440, 442 and 444 and the offset providers 250, 252 and 254 in FIG. 2.

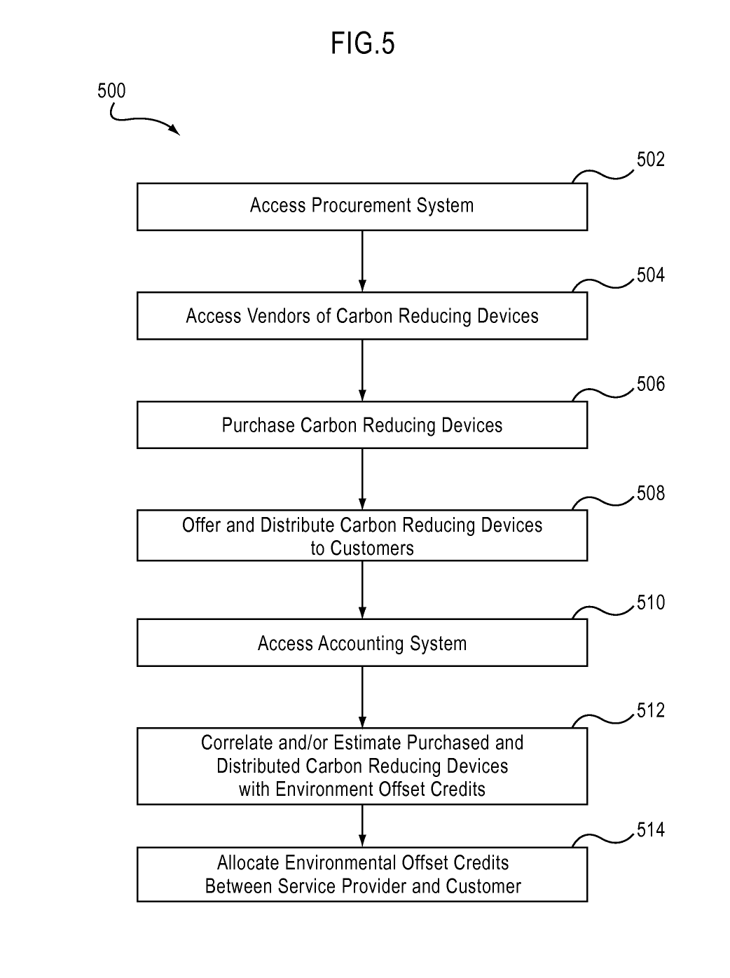

FIG. 5 describes a method 500 that enables a service provider to procure and account for carbon offset credits. At 502 the service provider, or other comparable system, accesses the procurement manager 420 via any known telecommunications link such as the internet or another wide area network. Procurement manager 420 is in communication with various vendors of carbon reducing devices and at 504 the procurement manager accesses these vendors. At 506 one or more carbon reducing devices are purchased by the procurement manager as directed by the service provider. At 508, the carbon reducing devices are offered to and then distributed to the service provider customers. In one specific embodiment, the carbon reducing devices are offered to the customers as a part of a marketing or other incentive program. At 510, the accounting manager or system is accessed by the service provider and the purchased or distributed carbon reducing devices are correlated and/or estimated with a certain amount of environmental offset credits (e.g. reduction in tons of CO2 per year) at 512. For example, the purchase and use of a quantity of compact fluorescent light bulbs may equate to the offset of 1 ton of carbon emissions per year. At 514 the environmental offset credits are allocated between the service provider and the customer. In one embodiment, the service provider receives credit for all of the offset credits associated with the purchase and use of the carbon reducing devices by the customer. In another embodiment, the customer receives the environmental offset credits. In another embodiment, the credits are divided (evenly or unevenly) between the customer and the service provider.

In another embodiment the service provider can set the allocation of credits and/or set the credit allocation range options when allocating environmental offset credits Between the service provider and the customer. By providing for setting the allocation of credits, the service provider mat set the parameters of the transaction where there is no allocation choice by the customer. This includes the case where all credits go to the service provider. By providing for setting the credit allocation range options, a customer may be given an option on allocation selection but the service provider still may set the range(s) and parameters of the transaction.

FIG. 6 shows a diagrammatic representation of one embodiment of a machine in the exemplary form of a computer system 600 within which a set of instructions for causing the device to perform any one or more of the aspects and/or methodologies of the present disclosure may be executed. Computer system 600 includes a processor 605 and a memory 610 that communicate with each other, and with other components, via a bus 615. Bus 615 may include any of several types of bus structures including, but not limited to, a memory bus, a memory controller, a peripheral bus, a local bus, and any combinations thereof, using any of a variety of bus architectures.

Memory 610 may include various components (e.g., machine readable media) including, but not limited to, a random access memory component (e.g., a static RAM “SRAM”, a dynamic RAM “DRAM, etc.), a read only component, and any combinations thereof. In one example, a basic input/output system 620 (BIOS), including basic routines that help to transfer information between elements within computer system 600, such as during start-up, may be stored in memory 610. Memory 610 may also include (e.g., stored on one or more machine-readable media) instructions (e.g., software) 625 embodying any one or more of the aspects and/or methodologies of the present disclosure. In another example, memory 610 may further include any number of program modules including, but not limited to, an operating system, one or more application programs, other program modules, program data, and any combinations thereof.

Computer system 600 may also include a storage device 630. Examples of a storage device (e.g., storage device 630) include, but are not limited to, a hard disk drive for reading from and/or writing to a hard disk, a magnetic disk drive for reading from and/or writing to a removable magnetic disk, an optical disk drive for reading from and/or writing to an optical media (e.g., a CD, a DVD, etc.), a solid-state memory device, and any combinations thereof. Storage device 630 may be connected to bus 615 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 630 may be removably interfaced with computer system 600 (e.g., via an external port connector (not shown)). Particularly, storage device 630 and an associated machine-readable medium 635 may provide nonvolatile and/or volatile storage of machine-readable instructions, data structures, program modules, and/or other data for computer system 600. In one example, software 625 may reside, completely or partially, within machine-readable medium 635. In another example, software 625 may reside, completely or partially, within processor 605. Computer system 600 may also include an input device 640. In one example, a user of computer system 600 may enter commands and/or other information into computer system 600 via input device 640. Examples of an input device 640 include, but are not limited to, an alpha-numeric input device (e.g., a keyboard), a pointing device, a joystick, a game-pad, an audio input device (e.g., a microphone, a voice response system, etc.), a cursor control device (e.g., a mouse), a touchpad, an optical scanner, a video capture device (e.g., a still camera, a video camera), touch-screen, and any combinations thereof. Input device 640 may be interfaced to bus 615 via any of a variety of interfaces (not shown) including, but not limited to, a serial interface, a parallel interface, a game port, a USB interface, a FIREWIRE interface, a direct interface to bus 615, and any combinations thereof.

A user may also input commands and/or other information to computer system 600 via storage device 630 (e.g., a removable disk drive, a flash drive, etc.) and/or a network interface device 645. A network interface device, such as network interface device 645 may be utilized for connecting computer system 600 to one or more of a variety of networks, such as network 650, and one or more remote devices 655 connected thereto. Examples of a network interface device include, but are not limited to, a network interface card, a modem, and any combination thereof. Examples of a network or network segment include, but are not limited to, a wide area network (e.g., the Internet, an enterprise network), a local area network (e.g., a network associated with an office, a building, a campus or other relatively small geographic space), a telephone network, a direct connection between two computing devices, and any combinations thereof. A network, such as network 650, may employ a wired and/or a wireless mode of communication. In general, any network topology may be used. Information (e.g., data, software 625, etc.) may be communicated to and/or from computer system 600 via network interface device 645.

Computer system 600 may further include a video display adapter 660 for communicating a displayable image to a display device, such as display device 665. A display device may be utilized to display any number and/or variety of indicators related to pollution impact and/or pollution offset attributable to a consumer, as discussed above. Examples of a display device include, but are not limited to, a liquid crystal display (LCD), a cathode ray tube (CRT), a plasma display, and any combinations thereof. In addition to a display device, a computer system 600 may include one or more other peripheral output devices including, but not limited to, an audio speaker, a printer, and any combinations thereof. Such peripheral output devices may be connected to bus 615 via a peripheral interface 670. Examples of a peripheral interface include, but are not limited to, a serial port, a USB connection, a FIREWIRE connection, a parallel connection, and any combinations thereof. In one example an audio device may provide audio related to data of computer system 600 (e.g., data representing an indicator related to pollution impact and/or pollution offset attributable to a consumer).

A digitizer (not shown) and an accompanying stylus, if needed, may be included in order to digitally capture freehand input. A pen digitizer may be separately configured or coextensive with a display area of display device 665. Accordingly, a digitizer may be integrated with display device 665, or may exist as a separate device overlaying or otherwise appended to display device 665.

Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention.

What is claimed is:

1. A system for offering and allocating environmental offset credits by a service provider, comprising:
an environmental credit management server in communication with the service provider and adapted to manage a consumer's selection and allocation of environmental offset credits;
a database management server in communication with the service provider and the consumer;
a plurality of environmental offset credit providers in communication with the database management server, the database management server adapted to store information concerning the plurality of environmental credit service providers, wherein the application management server is adapted to selectively provide information to the consumer concerning the plurality of environmental credit providers; and
a user interface provided through the environmental credit management server and adapted to enable the consumer to select one or more environmental offset credits from one or more of the plurality of environmental offset credit providers.

2. The system of claim 1, wherein the environmental credit management server comprises:
a service provider application interface;
a data aggregation module; and
a data distribution module.

3. The system of claim 2, wherein the service provider application interface is adapted to control the data aggregation module and the data distribution module, and wherein the data aggregation module receives information from the database management server.

4. The system of claim 2, wherein the service provider application interface is adapted to control the data aggregation module and the data distribution module and wherein the data aggregation module receives information from at least one of the plurality of environmental offset credit providers.

5. The system of claim 2, wherein the data distribution module provides information about the plurality of environmental offset credit providers to the consumer.

6. The system of claim 1, wherein the database management server is in communication with a plurality of data sources, wherein the plurality of data sources provide at least one environmental offset credit value to the database management server.

7. The system of claim 1, wherein the environmental credit management server provides the consumer with a selection of available environmental offset choices.

8. The system of claim 1, further comprising a procurement server in communication with the service provider and at least one vendor.

9. The system of claim 1, further comprising an accounting server in communication with the service provider.

10. A machine implemented method of offering and allocating environmental offset credits to a customer of a service provider, comprising:
receiving, from a database management server, information concerning a plurality of environmental credit service providers;
receiving, at an environmental credit management server in communication with the service provider, the information concerning the plurality of environmental credit service providers;
providing the information concerning the plurality of environmental credit service providers to the service provider customer; and
enabling, via a user interface provided by the environmental management server, the customer to select one or more environmental offset credits from one or more of the plurality of environmental offset credit providers.

11. The machine implemented method of claim 10, further comprising allocating the environmental offset credits to the service provider.

12. The machine implemented method of claim 10, further comprising allocating the environmental offset credits to the customer.

13. The machine implemented method of claim 10, further comprising allocating the environmental offset credits to a third party.

14. The machine implemented method of claim 10, further comprising allocating the environmental offset credits to both the service provider and the customer.

15. The machine implemented method of claim 10, further comprising accessing a procurement server to purchase at least one consumer product.

16. The machine implemented method of claim 15, further comprising accessing an accounting server to allocate the one or more environmental offset credit between the service provider and the customer.

17. A system for offering and allocating environmental offset credits by a service provider, comprising:
means for managing a consumer's selection and allocation of environmental offset credits;
means for accumulating and storing information concerning a plurality of environmental credit service providers;
means for selectively providing information to the consumer concerning the plurality of environmental credit service providers; and
means for enabling a user to select one or more environmental offset credits from one or more of the plurality of environmental offset credit providers.

18. The system of claim 17, further comprising means for providing standardized environmental offset credit data to the means for accumulating and storing information concerning a plurality of environmental credit service providers.

19. The system of claim 17, wherein the means for managing a consumer's selection and allocation of environmental offset credits is an application management server comprising a storage device, a display, an input device, a processor, a memory, a network interface, and a communications bus operatively connecting the storage device, the display, the input device, the processor, the memory, and the network interface.

20. The system of claim 17, further comprising means for purchasing one or more consumer products and means for allocating environmental offset credits between the service provider and the consumer.
